(19) United States
(12) Patent Application Publication
(10) Pub. No.: US 2008/0091781 A1
(43) Pub. Date: Apr. 17, 2008

(54) Group communication

(76) Inventors: Adamu Haruna, Tampere (FI); Miguel-Angel Garcia-Martin, Helsinki (FI)

Correspondence Address: Hollingsworth & Funk, LLC, Suite 125, 8009 34th Avenue South, Minneapolis, MN, 55425, US

(21) Appl. No.: 11/974,359

(22) Filed: Oct. 12, 2007

(30) Foreign Application Priority Data
Oct. 12, 2006 (FI) 20065651

(51) Int. Cl. G06F 15/16

(52) U.S. Cl. 709/205

(57) ABSTRACT

In order to provide a server of a network operator of a group message sender with feedback information relating to a delivery of the group message, the feedback information is obtained by the server delivering the group message and the feedback information is sent to the server of the network operator of the group message sender.

### FIELD OF THE INVENTION

The present invention relates to feedback information on group communication.

### BACKGROUND ART

The following description of background art may include insights, discoveries, understandings or disclosures or associations together with disclosures not known to the relevant art prior to the present invention but provided by the invention. Some such contributions of the invention may be specifically pointed out below, whereas other such contributions of the invention will be apparent from their context.

One special feature offered in communication systems is group communication. The term. “group”, as used herein, refers to any logical group of two or more users intended to participate in the same group communication. Examples of group communication include conferencing, multimedia conferencing, and chatting. Conferencing may use audio or video streams, for example, whereas chatting is a conference that utilizes instant messages. For a chat, participants may set up a chat room, which is a virtual place to exchange messages and corresponds to a session-based instant messaging conference. Chat rooms may be public, i.e. open to all or they may be private, i.e. the participation is restricted to given users. The basic principle of a chat is that a participant in the chat may send a message (an instant message) to one or more recipients so that they receive the message substantially simultaneously and each recipient may respond to the message. Typically participants are subscribers of different operators, and thus different operators are involved in chatting, and thereby each operator is providing required resources, such as servers. For example, operator B's server may host a chat room and a user who sends an instant message to other participants of the chat room may be operator A's subscriber, and therefore the message passes through one or more of operator A's servers, and possibly one or more servers of one or more other operators prior to arriving at operator B's server, which then delivers the message to other participants.

One of the problems associated with the above chat arrangement is that there is no mechanism to provide feedback information to operator A or more precisely, to operator A's server, on the message delivery, for example a number of recipients to whom the message was successfully delivered.

### SUMMARY

An object of the present invention is thus to provide a method and an apparatus for implementing the method so as to overcome the above problem. The object of the invention is achieved by a method, a signalling message, an apparatus and a computer program product which are characterized by what is stated in the independent claims. Preferred embodiments of the invention are disclosed in the dependent claims.

The invention is based on obtaining, on application level, feedback information relating to the delivery of a group message. The obtained feedback information may be sent in an application level protocol message to a server in a network of an operator of a sender of the group message. The feedback information may be obtained and sent in response to a request received from the server.

An advantage of the invention is that it provides an easy-to-implement application level solution to obtaining feedback information which enables differentiated charging, for example.

### BRIEF DESCRIPTION OF THE DRAWINGS

In the following, embodiments will be described in greater detail with reference to the accompanying drawings, in which

FIG. 1 illustrates an example of the general architecture of a communication system providing a group communication service;

FIG. 2 is a simplified block diagram of an apparatus according to an embodiment of the invention;

FIG. 3 is a simplified block diagram of a server component according to an embodiment of the invention;

FIGS. 4, 5 and 6 are signalling diagrams illustrating signalling according to embodiments of the invention;

FIGS. 7 and 8 are flow charts illustrating functionalities of server components according to embodiments of the invention; and

FIGS. 9 to 11 illustrate different messages according to embodiments of the invention.

### DETAILED DESCRIPTION OF SOME EMBODIMENTS

The following embodiments are exemplary. Although the specification may refer to “an”, “one” or “some” embodiment(s) in several locations, this does not necessarily mean that each such reference is to the same embodiment(s) or that the feature only applies to a single embodiment. Single features of different embodiments may also be combined to provide other embodiments.

The present invention is applicable to any user terminal, server, corresponding component, and/or to any communication system or any combination of different communication systems that support group communication. The communication system may be a fixed communication system or a wireless communication system or a communication system utilizing both fixed networks and wireless networks. The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, the embodiment.

In the following, the present invention will be described using, as an example of group communication, a chat using instant messages and, as an example of a system architecture whereto the present invention may be applied, an architecture based on SIP (session initiation protocol) for signaling and session establishment, i.e. providing a tool to build a multimedia architecture, and MSRP (message session relay protocol) for group communication without restricting the invention to such a group communication and to such an architecture, however. SIP and MSRP are defined by the Internet Engineering Task Force (IETF). SIP is an application-layer control (signalling) protocol for creating, modifying, and terminating sessions with one or more participants. MSRP is an application layer protocol for carrying a series of instant messages between two points, as one-to-one or one-to-many communication, after a session has been established. In other words, SIP and MSRP are not vertically integrated into a communication system. IETF specifications and Internet Drafts can be found at http://www.ietf.org.

The general architecture of a communication system providing a group communication service utilizing SIP and MSRP is illustrated in FIG. 1. FIG. 1 is a simplified system architecture only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for group communication, are irrelevant to the actual invention. Therefore, they need not be discussed in more detail here.

The communication system 1-1 in FIG. 1 comprises user terminals 1-2, 1-2′, 1-2″ each connectable via an operator network 1-4, 1-4′ to a server 1-3, 1-3′ of its own network operator, each operator network including preferably an access network and a core network and being connected to other operator networks via a routing network 1-5, such as the Internet or GPRS (general packet radio service) roaming exchange.

In the following it is assumed, without restricting the invention thereto, that an operator A's server, a server A 1-3, is an instant messaging server via which users using subscriptions of the operator A, i.e. user terminals 1-2, 1-2′, gain access to a chat room server, a server B 1-3′, providing chat room services, such as delivery of an instant message to other participants of the chat room, called recipients below. Preferably, as illustrated in the example, the chat room server, the server B, which is an operator B's server, provides access to chat room services to users using subscriptions of the operator B, i.e. the server B 1-3′ acts also as an instant messaging server of the operator B.

It should be appreciated that a chat room in the server B may provide access to chat room services for any number of different operators or more precisely, for users using their subscriptions. In other words, the operator A's network 1-4, the server A 1-3 and the user terminals-1-2, 1-2′ represent here one or more corresponding operator networks, intermediate servers and user terminals. It should also be appreciated that access to different chat rooms may be provided by different chat servers of different operators. In other words, the operator B's network 1-4′, and the server B 1-3′ represent here one or more corresponding operator networks and servers providing group communication.

FIG. 2 is a block diagram of an apparatus according to an embodiment of the invention. Although the apparatus has been depicted as one entity, different modules and memory may be implemented in one or more physical or logical entities. The apparatus 200 is configured to obtain feedback information with the help of a chat room server or a corresponding group communication server, as will be described below. For this purpose, the apparatus comprises data storage 20 for storing received feedback information at least temporarily, a service provider unit 21 for providing access to chat services or other group communication, a receiving unit 22 for receiving different inputs, information and messages, and a sending unit 23 for sending different outputs, information and messages.

The functionality of the service provider unit 21 is described in more detail below. It should be appreciated that the apparatus may comprise other units used in or for accessing the chat server or a corresponding group communication server or providing instant messaging or other group communication. However, they are irrelevant to the actual invention and, therefore, they need not to be discussed in more detail here.

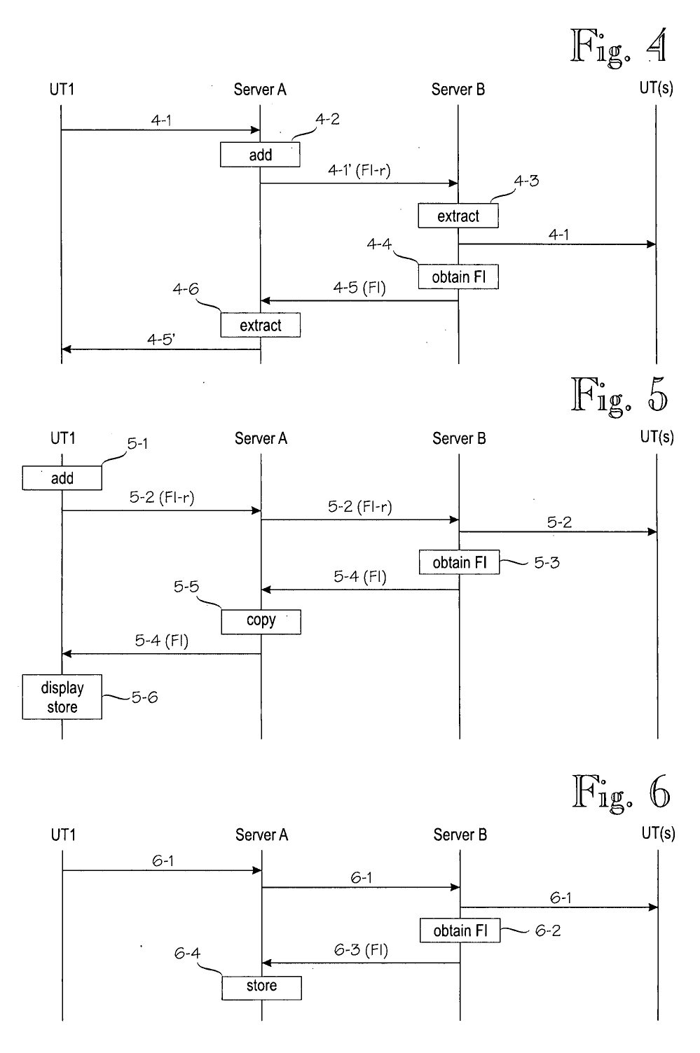

The apparatus may be any node or a host which is able to communicate with a group communication server of the system, via one or more access networks and core networks and a routing network. Different functionalities of such an apparatus are shown below in FIGS. 4 to 7. The apparatus may be an instant messaging server, such as a relay server or back-to-back-user-agent which is a SIP based logical entity that can receive and process INVITE messages as a SIP User Agent Server or any other intermediate server. The apparatus may also be a user terminal which is a piece of equipment or a device that associates or is arranged to associate, the user terminal and its user with a subscription and allows a user to interact with a communications system. The user terminal presents information to the user and allows the user to input information. In other words, the user terminal may be any terminal capable of receiving information from and/or transmitting information to the network, connectable to the network wirelessly or via a fixed connection. Examples of the user terminal include a personal computer, a game console, a laptop (a notebook), a personal digital assistant, a mobile station (mobile phone), and a line telephone.

Apparatuses, such as intermediate servers or corresponding intermediate server components, user terminals and/or other corresponding devices or apparatuses implementing the functionality of a corresponding apparatus described in an embodiment comprise not only prior art means, but also means for forming, sending and/or receiving messages requesting feedback information or containing feedback information in a manner described below. In addition, they may comprise means for adding a request of feedback information to a group message or means for removing feedback information from a message in a manner described below. More precisely, they comprise means for implementing the functionality of a corresponding apparatus described in an embodiment and they may comprise separate means for each separate function or means may be configured to perform two or more functions. Present apparatuses comprise processors and memory that can be utilized in the functions according to an embodiment. For example, the service provider unit 21 may be a software application or a module or a unit configured as an arithmetic operation or as a program, executed by an operation processor. All modifications and configurations required for implementing the functionality of an embodiment may be performed as routines, which may be implemented as added or updated software routines, application circuits (ASIC) and/or programmable circuits. Software routines, also called program products, including applets and macros, can be stored in any apparatus-readable data storage medium and they include program instructions to perform particular tasks. Software routines may be downloaded into an apparatus. The apparatus, such as an intermediate server or a corresponding intermediate server component or a user terminal may be configured as a computer including at least a memory for providing storage area used for arithmetic operation and an operation processor for executing the arithmetic operation. An example of the operation processor includes a central processing unit. The memory may be removable memory detachably connected to the apparatus.

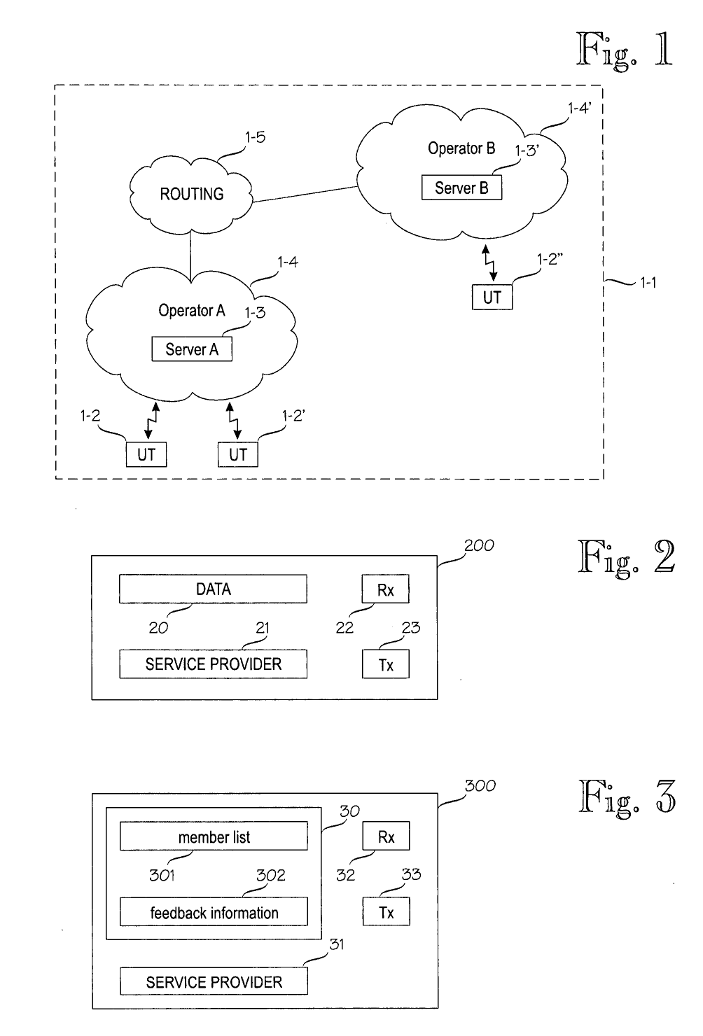

FIG. 3 is a block diagram of a group server or a corresponding group server component, according to an embodiment of the invention. Although the server has been depicted as one entity, different modules and databases/memory may be implemented in one or more physical or logical entities. The server 300 is configured to manage data on group communication, such as chat rooms. In the illustrated example it is assumed that a chat room exists. For managing data on the chat room, the server comprises data storage 30 with a member list 301 for storing information on participants who have joined the group communication, such as a chat room, and/or are members of a group and/or members of a group communication session, i.e. are chat members, and feedback information 302 for storing at least temporarily collected feedback information on group message delivery. In addition, the server comprises a service provider unit 31 for providing group message delivery (also called distribution) to recipients, a receiving unit 32 for receiving different inputs, information and messages, and a sending unit 33 for sending different outputs, information and messages.

The functionality of the service provider unit 31 is described in more detail below in FIGS. 4, 5, 6 and 8. It should be appreciated that the service provider unit may comprise other units used in or for the group communication service, such as the chat service, and the instant messaging service. However, they are irrelevant to the actual invention and, therefore, they need not be discussed in more detail here.

Apparatuses, such as group servers or corresponding group server components, and/or other corresponding devices or apparatuses implementing the functionality of a corresponding apparatus described in an embodiment comprise not only prior art means, but also means for forming, sending and/or receiving messages requesting feedback information or containing feedback information in a manner described below. In addition, they may comprise means for extracting a request for feedback information from a group message or means for collecting feedback information in a manner described below. More precisely, they comprise means for implementing the functionality of a corresponding apparatus described in an embodiment and they may comprise separate means for each separate function or means may be configured to perform two or more functions. Present apparatuses comprise processors and memory that can be utilized in the functions according to an embodiment. For example, the service provider unit 31 may be a software application or a module or a unit configured as arithmetic operation or as a program, executed by an operation processor. All modifications and configurations required for implementing the functionality of an embodiment may be performed as routines, which may be implemented as added or updated software routines, application circuits (ASIC) and/or programmable circuits. Software routines, also called program products, including applets and macros, can be stored in any apparatus-readable data storage medium and they include program instructions to perform particular tasks. Software routines may be downloaded into an apparatus. The apparatus, such as a group server or a corresponding group server component may be configured as a computer including at least a memory for providing storage area used for arithmetic operation and an operation processor for executing the arithmetic operation. An example of the operation processor includes a central processing unit. The memory may be removable memory detachably connected to the apparatus.

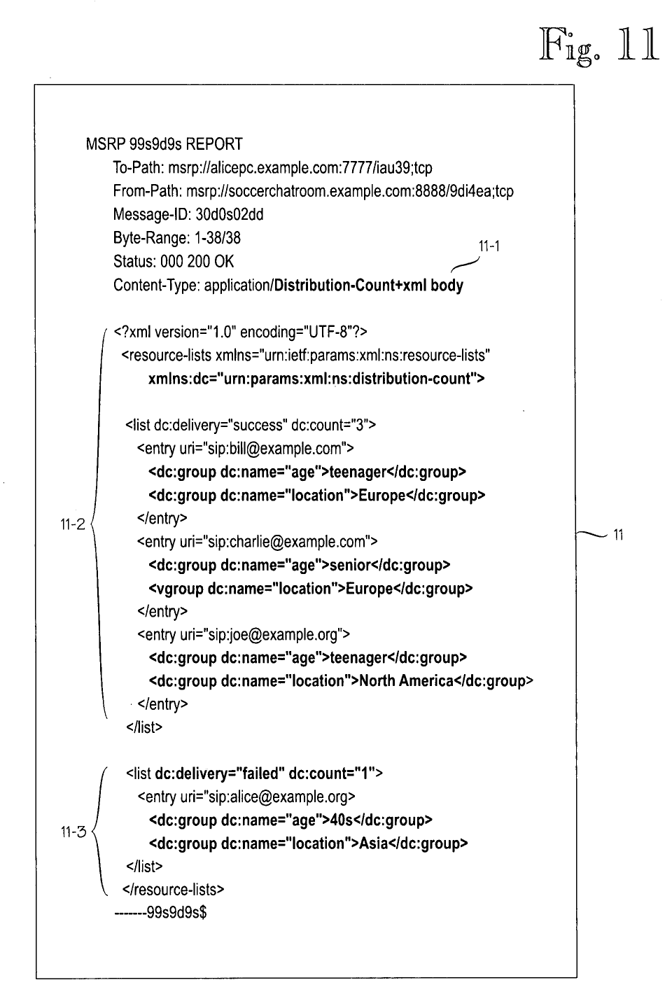

In the following, different embodiments illustrating apparatus and/or server operations and how they process application level signalling messages are described using an instant message as a group message, a chat with a chat room as a group communication, the operator A's server, called the server A, as a sender's instant messaging server, and the operator B's server, called the server B, as a server hosting the chat room without restricting the invention thereto. It should also be appreciated that the server operations may be implemented in one or more physical or logical entities. In the following, the delivery of an instant message to other participants is not disclosed in detail for the sake of clarity. The delivery includes sending the instant message to recipients via their instant message servers, and receiving acknowledgements via the corresponding instant message servers, including the server A. Examples of different messages that can be used in FIGS. 4 to 6 are disclosed in more detail below in FIGS. 9 to 11.

FIG. 4 illustrates signalling according to an embodiment of the invention. In the example illustrated in FIG. 4, it is assumed, for the sake of clarity, that a user of a user terminal UT1 has joined a chat room and is able to send instant messages to the chat room for delivery to other participants of the chat. A further assumption made here is that a server A is an operator A's server, the operator A being an operator associated with the user terminal A, and that a server B hosts the chat room and is an operator B's server. It is further assumed, for the sake of clarity, that other participants are individual users, but one or more of the participants in the delivery list may be recipient groups. For example, participants may be divided into subgroups so that members of a subgroup share one or more common characteristics. Examples of characteristics that may be used to divide participants into subgroups include age, job position, marital status, affiliations, country of residence and hobbies.

The user of the user terminal UT1 sends an instant message 4-1 to the chat room. The instant message 4-1 may be an MSRP SEND request, for example. In response to receiving the instant message 4-1, the server A adds, in point 4-2, to the message a request for feedback information (FI_r), and forwards the instant message with the request to the server B in message 4-1′. The requested feedback information may be the number of recipients the user content (group message) was successfully sent to, and/or the number of recipients the user content (group message) was not delivered due to a failure, and/or the number of recipients on a delivery list, and/or the number and/or types of recipient groups, for example. Further; the request may include instructions how to divide recipients to different subgroups, by giving one or more of the characteristics, for example. It should be appreciated that other feedback information which is not disclosed herein, may be requested. Depending on implementation, the server A may be configured to request each time the same feedback information or the requested feedback information may depend, at least partly, on the subscription associated with the user terminal UT1 or on the content type of the message.

When the server B receives the instant message, the server B extracts, in point 4-3, the feedback information request from the message and, after that, delivers instant messages 4-1 to other participants who have joined the chat room. In response to the feedback information request in the message 4-1′, the server B obtains, in point 4-4, the requested feedback information. Depending on the requested feedback information, the obtaining may include waiting for acknowledgements from recipients, the acknowledgements indicating success or failure of the delivery, for example, and collecting feedback information on the basis of the acknowledgements. The acknowledgement may be a 200 OK or an MSRP REPORT request. For the sake of clarity, these acknowledgements are not disclosed in FIG. 4.

When the server B has obtained the requested feedback information, the server B sends the feedback information (FI) in message 4-5 towards the user terminal UT1. Thus, message 4-5 passes through the server A, which extracts, in point 4-6, the feedback information from the message and stores the feedback information at least temporarily for further processing and/or for sending to another network node, such as a node collecting charging information, for example. The server A then forwards the message without the feedback information to the user terminal UT1 in message 4-5′. The message 4-5 and the message 4-5′ may be a response, such as 200 OK, another request, such as MSRP REPORT request or any other acknowledgement. In another embodiment of the invention, the server A may send message 4-5′ or a corresponding additional acknowledgement message in response to receiving message 4-1.

An advantage of the server A explicitly requesting specific feedback information is that the server A can control when and what kind of feedback information it will obtain. This facilitates versatile charging of subscriptions, either between different subscriptions of an operator and/or between different operators, for example.

An advantage of the feedback information not being sent to the user terminal is that sending of the feedback information, especially when very detailed feedback information is requested, remains interdomain, i.e. from a server to another server, and therefore does not create extra load to the air interface of the user terminal.

FIG. 5 illustrates signalling according to another embodiment of the invention. The assumptions relating to FIG. 5 are the same as those relating to FIG. 4, and therefore they are not repeated here.

In the embodiment illustrated in FIG. 5, the user terminal is configured to add, in point 5-1, a request for feedback information (FI_r) to an instant message 5-2, which is sent to a chat room. The instant message 5-2 may be an MSRP SEND request, for example. Examples of the feedback information are given above in FIG. 4. Depending on the implementation, the user and/or the user terminal, and/or an identity module in the user terminal, such as a SIM (subscriber identity module) card, for example, may be configured to add the request to the instant message prior to the message being sent.

The instant message 5-2 passes through the server A to the server B which delivers instant messages 5-2 to other participants who have joined the chat room. Depending on the implementation, the server B may or may not extract the feedback information request from the instant message before it is delivered. In response to the feedback information request in the message 5-2, the server B obtains, in point 5-3, the requested feedback information. As stated above in FIG. 4, the obtaining may include waiting for acknowledgements from recipients and combining them. For the sake of clarity, these acknowledgements are not shown in FIG. 5. When the server B has obtained the requested feedback information, the server B sends the feedback information (FI) in message 5-4 towards the user terminal UT1. The message 5-4 may be a response, such as 200 OK, another request, such as MSRP REPORT request or any other acknowledgement.

In response to receiving message 5-4 containing feedback information, the server A copies the feedback information, e.g. stores or forwards it to another node, in point 5-5, and forwards the message to the user terminal UT1, which then may display, in point 5-6, the feedback information to the user of the user terminal UT1, and/or store it at least temporarily.

FIG. 6 illustrates signalling according to a further embodiment of the invention. The assumptions relating to FIG. 6 are the same as those relating to FIG. 4, and therefore they are not repeated here.

In the embodiment illustrated in FIG. 6, the server B, i.e. the server hosting the chat room, provides the server A with feedback information without any specific request from the server A (or from user terminal UT1). The server B may be configured to provide all different servers A, i.e. independently of the operator associated with user terminal UT1, with the same feedback information or the provided feedback information may depend on an agreement between operators, i.e. be operator-specific, for example. However, in the example illustrated, it is assumed, for the sake of clarity, that the server B is configured to provide all operators with the same feedback information.

Referring to FIG. 6, the user of the user terminal UT1 sends an instant message 6-1 to the chat room via the server A. In response to receiving the instant message, the server B delivers instant messages 6-1 to other participants who have joined the chat room, and obtains, in point 6-2, feedback information on the delivery. As stated above in FIG. 4, the obtaining may include waiting for acknowledgements and combining them. For the sake of clarity, these acknowledgements are not disclosed in FIG. 6. When the server B has obtained the feedback information, the server B sends the feedback information (FI) in message 6-3 towards the user terminal UT1. The message 6-3 may be a response, such as 200 OK, another request, such as MSRP REPORT request or any other message.

In response to receiving message 6-3, the server A stores, in point 6-4, the feedback information or forwards it to another node. The server A may be configured to discard, in point 6-4, the feedback information, if the server A does not need it, instead of storing it.

In another embodiment, the server A may forward message 6-3 to the user terminal UT1.

The above example illustrated in FIG. 6 may be used in an embodiment in which, when during the user terminal UT1 joining the chat room, the request for feedback information is submitted to the server B.

A further embodiment in which the example illustrated in FIG. 6 may be used, is an embodiment in which the server B is configured to provide feedback information on subsequent messages sent by the user terminal UT1 after a first message requesting feedback information is received until a message is received which either cancels the feedback information request or requests for other feedback information.

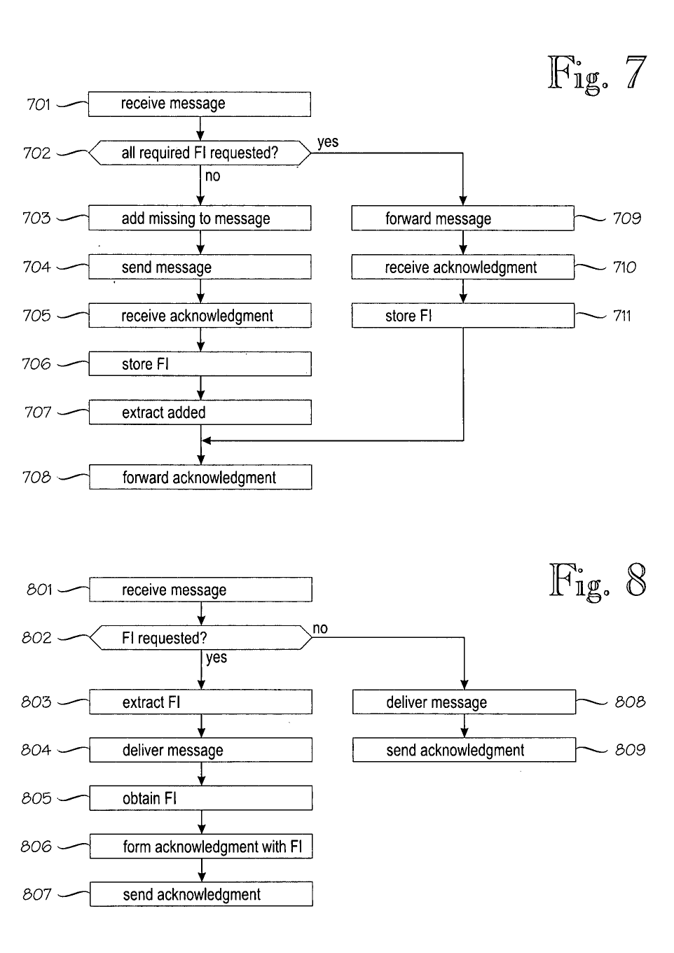

FIG. 7 is a flow chart illustrating the functionality of a server component according to an embodiment of the invention, the server component serving a sender of a group message, such as a chat message targeted to a chat room. In other words, FIG. 7 illustrates the functionality of an intermediate application server, and it should be appreciated that forwarding a message covers here generating a similar copy and sending it. The intermediate application server may be a server serving the sender of the group message or another intermediate server through which the group message passes.

In response to receiving a group message (step 701), the server component checks, in step 702, whether or not the message contains a feedback information request requesting for all required feedback information (FI). The required feedback information may be subscriber-specific information, and/or operator-specific information, and/or session-specific information, i.e. it may depend on the chat room in question. It is also possible that no feedback information is required. Examples of different feedback information are given above in FIG. 4.

If any of the required feedback information is not requested, a request for the feedback information is added, in step 703, to the group message, which is then sent, in step 704, towards the chat room. After a while, an acknowledgement with the requested feedback information is received in step 705. Examples of different acknowledgments are given above in FIG. 4. In response to the acknowledgement, the feedback information is stored, in step 706, and feedback information relating to a request or requests added in step 703 is extracted, in step 707, from the acknowledgement. Then the acknowledgement is forwarded, in step 708, towards the sender of the group message.

If all required feedback information is already requested for in the received group message (step 702), the group message is forwarded, in step 709, to the server hosting the group communication, such as a chat room. After a while, an acknowledgement with the requested feedback information is received in step 710. Examples of different acknowledgments are given above in FIG. 4. In response to the acknowledgement, the feedback information is stored, in step 711, and the acknowledgement is forwarded, in step 708, towards the sender of the group message. If no feedback information was required and requested, the storing step 711 is skipped.

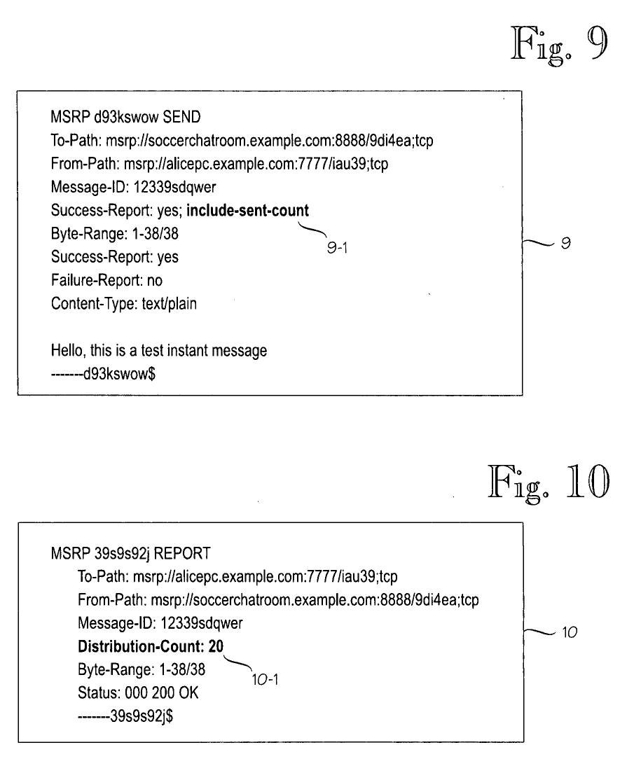

FIG. 8 is a flow chart illustrating the functionality of a server component according to an embodiment of the invention, the server component hosting a chat room and delivering a group message to participants of the chat.

In response to receiving the group message (step 801), the server component checks, in step 802, whether or not the message contains a feedback information request (FI_r). Examples of different feedback information are given above in FIG. 4.

If the group message contains a feedback information request (step 802), the server component extracts, in step 803, the request from the group message and then delivers, in step 804, the group message to recipients. The server component then obtains, in step 805, the requested feedback information. The obtaining step may include receiving acknowledgements indicating successful delivery or failed delivery from recipients and combining them or information thereon. When the feedback information is obtained, the server component forms, in step 806, an acknowledgement containing the requested feedback information (FI), and sends, in step 807, the acknowledgement towards the sender of the group message. Examples of acknowledgements are given above with FIG. 4.

If the group message does not contain a feedback information request (step 802), the server components delivers, in step 808, the group message to recipients, and sends, in step 809, an acknowledgement towards the sender of the group message. Examples of acknowledgements are given above in FIG. 4. The server component may wait for acknowledgements from recipients prior to sending the acknowledgement towards the sender, i.e. prior to step 809.

The steps/points, signaling messages and related functions described above in FIGS. 4 to 8 are in no absolute chronological order, and some of the steps/points may be performed simultaneously or in an order differing from the given one. Other functions can also be executed between the steps/points or within the steps/points and other signaling messages sent between the illustrated messages, such as the servers acknowledging a received message. Some of the steps/points or part of the steps/points can also be left out or replaced with a corresponding step/point or part of the step/point. The server operations illustrate a procedure that may be implemented in one or more physical or logical entities. The signaling messages are only exemplary and may even comprise several separate messages for transmitting the same information. For example, the request for feedback information on a group message may be sent in another message than the group message. In addition, the messages may also contain other information. Furthermore, the messages may pass through one or more other servers in the operator A's network, and/or in the operator B's network, and/or in another operator's network.

FIGS. 9 to 11 disclose messages according to the invention, FIG. 9 an example of a message requesting feedback information and FIGS. 10 and 11 are examples of messages containing feedback information. Examples of new parameters or header fields are bolded in FIGS. 9 to 11. The messages may be any suitable application level signalling messages but, for the sake of clarity, they are illustrated as simplified MSRP messages not containing, for the sake of clarity, all possible header fields and parameters.

In the embodiment illustrated in FIG. 9, a message 9 contains a new parameter ‘include-sent-count’ 9-1 indicating that the requested feedback information relates to a number of successfully sent messages. The message 9 is a MSRP SEND request. The value of the new parameter may be any of those disclosed with FIG. 4 or any other value indicating the requested feedback information, and the message may also contain two or more new parameter values.

In the embodiment illustrated in FIG. 10, a message 10 is an acknowledgement to the message 9. The message 10 is an MSRP REPORT request including, as a new parameter or a header field, the requested feedback information 10-1 (or feedback information defined to be provided to another server), which in this case is ‘distribution-count: 20’ indicating that the message was successfully delivered to 20 recipients. In another embodiment of the invention, the number may indicate the total sum of failed deliveries and successful deliveries.

In the embodiment illustrated in FIG. 11, a message 11 is an MSRP REPORT request including the requested feedback information (or feedback information defined to be provided to another server), which in this case contains detailed information on the recipients, including the group a recipient belongs to. The MSRP REPORT request illustrated in the example of FIG. 11 contains an XML document 11-1 that provides detailed information 11-2 on the URIs of the recipients (and number of recipients) who received the instant message, and detailed information 11-3 on those recipients who failed to receive the instant message. It also contains the name of the groups each recipient belongs to.

As stated above, instead of the MSRP REPORT request another acknowledging message, such as 200 OK, may be used to contain the feedback information disclosed in FIGS. 10 and 11.

It should be appreciated that the above signaling messages are only examples. For example, an instant messages delivery notification, defined currently by the IETF, may be enhanced to convey the above illustrated feedback information. The enhanced instant messages delivery notification document may be included in an MSRP REPORT request or to 200 OK.

The group server or an intermediate server, may act as an aggregator and aggregate acknowledgements, such as instant messages delivery notification documents, into a single acknowledgement to be sent as aggregated feedback information in a message. However, it is possible that the feedback information may be sent piece by piece, i.e. each acknowledgment received from a recipient is sent as separate feedback information in a message or the feedback information may comprise one or more messages containing aggregated feedback information and/or one or more messages containing separate feedback information.

Although not mentioned above in detail, the feedback information facilitates charging. With the feedback information, for example a charge of an instant message may depend on the subgroups whose members received the message, on the countries where it was received, and/or on the number of receivers. Further, it enables operators providing the required resources to share the charges. This is especially useful when several cascaded group communication servers are used in the delivery of the message.

It will be obvious to a person skilled in the art that, as technology advances, the inventive concept can be implemented in various ways. The invention and its embodiments are not limited to the examples described above but may vary within the scope of the claims.

1. A method comprising:
obtaining feedback information on a delivery of a group message to group members; and
sending the obtained feedback information in an application level message to a server component providing access to group communication to a sender of the group message.

2. A method as claimed in claim 1, further comprising requesting the feedback information with the group message, and obtaining the feedback information in response to the request.

3. A method as claimed in claim 1, further using the group members' acknowledgements to obtain the feedback information.

4. An apparatus, comprising:
a processor; and
a memory unit communicatively connected to the processor and including
computer code for forming an application level signaling message of a group communication service requesting feedback information on delivery of a group message to group members.

5. An apparatus according to claim 4, wherein the memory unit further includes computer code for forming an application level signaling message containing a header field or one or more parameters in a header for requesting for the feedback information.

6. An apparatus according to claim 4, wherein the formed application level signaling message is a message session relay protocol send request.

7. An apparatus according to claim 4 wherein the memory unit includes computer code for forming the application level signaling message requesting for feedback information, wherein the feedback information includes one or more from a group comprising
a number of recipients the group message was successfully sent to, a number of recipients the group message was not delivered to due to a failure, a number of recipients on a delivery list, and a number and/or types of recipient groups.

8. An apparatus according to claim 4, wherein the apparatus is an intermediate server component and the memory unit further includes computer code for adding, in response to the apparatus receiving as the application level signaling message a group message to be forwarded to a server component providing the delivery of the group message, to the group message a request for feedback information.

9. An apparatus according to claim 8, wherein the memory unit further includes computer code for checking, in response to the apparatus receiving the group message, whether or not the group message contains a request for required feedback information; and
the computer code for adding is configured add to the group message a request for the required feedback information that is missing.

10. An apparatus according to claim 8, wherein the memory unit further includes computer code for extracting, in response to the apparatus receiving a response to the request, from the response, the feedback information the apparatus requested.

11. An apparatus, comprising:
a processor; and
a memory unit communicatively connected to the processor and including
computer code for forming an application level signaling message of a group communication service, the message containing feedback information on delivery of a group message to group members.

12. An apparatus according to claim 11 wherein the memory unit further includes computer code for forming an application level signaling message containing a header field or one or more parameters in a header containing the feedback information.

13. An apparatus according to claim 11 wherein the memory unit further includes computer code for forming an application level signaling message containing an XML document containing the feedback information or an instant message delivery notification document enhanced to contain the feedback information.

14. An apparatus according to claim 11 wherein the formed application level signaling message is a message session relay protocol report request.

15. An apparatus according to claim 11 wherein the memory unit includes computer code for forming the application level signaling message containing feedback information, wherein the feedback information includes one or more from a group comprising a number of recipients the group message was successfully sent to, a number of recipients the group message was not delivered to due to a failure, a number of recipients on a delivery list, and a number and/or types of recipient groups.

16. An apparatus according to claim 11, the apparatus being a server component providing the delivery of the application level signaling message to group members, wherein the formed application level signaling message contains aggregated feedback information.

17. An apparatus according to claim 11, wherein the apparatus is an intermediate server component and the memory unit further includes computer code for adding, in response to the apparatus receiving as the application level signaling message a group message to be forwarded to a server component providing the delivery of the group message, to the group message a request for feedback information.

18. An apparatus according to claim 17, wherein the memory unit further includes computer code for checking, in response to the apparatus receiving the group message, whether or not the group message contains a request for required feedback information; and
the computer code for adding is configured add to the group message a request for the required feedback information that is missing.

19. A computer program product embodied in a device-readable medium and comprising program instructions, wherein execution of said program instructions causes a device containing the computer program product to form an application level signaling message, the message containing feedback information on a delivery of a group message to group members.

20. A computer program product according to claim 19, wherein the application level signaling message contains a header field or one or more parameters in a header containing the feedback information.

21. A computer program product according to claim 19, wherein the application level signaling message contains an XML document containing the feedback information or an instant message delivery notification document enhanced to contain the feedback information.

22. A computer program product according to claim 19, wherein the application level signaling message is a message session relay protocol report request.

23. A computer program product according to claim 19, wherein the feedback information includes one or more from a group comprising a number of recipients the group message was successfully sent to, a number of recipients the group message was not delivered to due to a failure, a number of recipients on a delivery list, and a number and/or types of recipient groups.

24. A computer program product according to claim 19, wherein the formed application level signaling message contains aggregated feedback information.

25. A system comprising, an apparatus that comprises
a processor and a memory unit communicatively connected to the processor and including:
computer code for forming an application level signaling message of a group communication service, the message containing feedback information on delivery of a group message to group members.
